(19) United States
(12) Patent Application Publication
(10) Pub. No.: US 2013/0307756 A1
(43) Pub. Date: Nov. 21, 2013

(54) DISPLAY APPARATUS

(71) Applicant: SEEPER LIMITED, London (GB)

(72) Inventors: David Sweeney, London (GB); Marek Bereza, London (GB); Duncan Fitzsimons, London (GB); Evan Grant, London (GB)

(73) Assignee: SEEPER LIMITED, London (GB)

(21) Appl. No.: 13/895,048

(22) Filed: May 15, 2013

Related U.S. Application Data
(60) Provisional application No. 61/656,334, filed on Jun. 6, 2012.
(60) Provisional application No. 61/657,072, filed on Jun. 8, 2012.

(30) Foreign Application Priority Data
May 16, 2012 (GB) 1208597.3

(51) Int. Cl. G09G 5/02

(52) U.S. Cl. CPC G09G 5/02
USPC 345/31

(57) ABSTRACT

A display apparatus includes an array of pixel elements, each of which can be illuminated by light shone from an individual light source for each pixel. The display apparatus has a base configuration in which the pixel elements form a substantially continuous surface. Each pixel element is mounted on an individual hollow support member that transmits light from the light source to that pixel and has walls that prevent leakage of light. The support member is displaced in forwards and rearward directions by a drive mechanism provided for displacing each support member individually.

### RELATED APPLICATIONS

This application claims priority from United Kingdom Patent Application No. 1208597.3 filed on May 16, 2012, U.S. Provisional Patent Application No. 61/656,334 filed on Jun. 6, 2012, and U.S. Provisional Patent Application No. 61/657,072 filed on Jun. 8, 2012, each of which is hereby incorporated herein by reference.

### FIELD OF THE INVENTION

This invention relates to a display apparatus. In particular, the invention relates to a display apparatus which includes an array of mechanical pixel elements, each of which can display a selection of colors.

### BACKGROUND TO THE INVENTION

So called “flip disc” displays are well known in which there is an array of pixels, each of which is a disc which can be flipped between displaying a color on one side of a disc and displaying a color on the other side of a disc. Typically, one side of the disc is black and the other side of the disc is a bright color, such as yellow. To display an alphanumeric character, for example, the discs which make up the pixels of the character will be flipped to display the bright color, whilst the surrounding discs display black. Such displays have been used to display departure and arrival information at airports and railway stations, for example. These displays have now frequently been replaced by electronic screens provided by plasma displays, liquid crystal displays or light emitting diode displays.

### SUMMARY OF THE INVENTION

The present invention aims to provide a display that includes an array of mechanical pixel elements, which can display material in a manner that conventional electronic plasma, liquid crystal or light emitting diode screens cannot.

One aspect of the invention provides a display apparatus that includes an array of pixel elements, each of which can be illuminated by light shone from an individual light source for each pixel element, the display apparatus having a base configuration in which the pixel elements form a substantially continuous surface, wherein each pixel element is mounted on an individual elongate hollow support member that transmits light from the light source to that pixel element and has walls that prevent leakage of light, and a drive mechanism is provided for displacing each support member individually in forwards and rearward directions.

Another aspect of the invention provides a display apparatus that includes a frame carrying a plurality of parallel elongate, tubular support members arranged in a rectangular array, first ends of each support member terminating in a rectangular translucent pixel element, and second ends of each support member being open; each support member being associated with an individual drive mechanism mounted on the support for driving the support member in a longitudinal direction in a forwards sense and in a rearwards sense; each support member also being associated with an individual light source which is arranged to direct light through the open end of the support member and along the support member so as to illuminate the pixel element, each support member having at least one opaque wall which constrains light from the source within the support member until it reaches the pixel element; wherein a data processing module provides control signals to the individual light source and to the individual drive mechanism for each support member, thereby controlling the color and the spatial position of each pixel element independently.

Another aspect of the invention provides a display apparatus that includes an array of pixel elements, each of which can display a selection of colors, and a color control system that control the color that is displayed by each individual pixel element, the display apparatus having a base configuration in which the pixel elements form a substantially continuous surface; wherein each pixel element is mounted on an individual support member that can be displaced individually in directions away from and back towards said surface, by a drive mechanism.

In preferred embodiments, there are means for controlling the extent to which each individual support member is displaced.

In preferred embodiments, a data processing module is provided which is arranged to receive data representing material to be displayed on the display apparatus, and to control the colors of the individual pixels and their individual spatial positions through operation of the drive mechanisms, so as to display the material.

Viewed from another aspect, the invention provides a method of operating such display apparatus, wherein data representing material to be displayed on the display apparatus is input to the data processing control module, and the data processing control module controls the colors of the individual pixels and their individual spatial positions through operation of the drive mechanism, so as to display the material.

In accordance with the invention, whatever is displayed on the display apparatus can be defined by different colors of the individual pixel elements, and by the spatial position of the individual pixel elements. A vivid, three dimensional effect can be provided.

Typically, the base configuration will be one in which the surface is flat, with all of the pixel elements lying in the same plane. However, the base configuration could be one in which the surface is curved. A curved surface could for example be convex or concave or could be a mixture of concave and convex portions.

In some embodiments, each individual pixel element has a flat, forward facing surface which displays the selected color for that pixel at any given time. The forward facing surface could be rectangular, such as square or circular, triangular or any other shape. However in some embodiments of the invention the pixel elements can display colors by having a three dimensional display arrangement. For example, the pixel elements could be convex so as to display the colors both forwards and in lateral directions (i.e. any or all of left, right up and down). The pixel elements could display colors in substantially all directions, for example being in the form of spheres.

From the base configuration, the arrangement may be such that the support members could be displaced in a forwards direction only, and in the return direction. However, the support members could be displaced in a rearwards direction only, and in the return direction, or the support members could be displaced in either a forwards or a rearwards direction from the base configuration, and in the return directions.

What is displayed may be static for a period of time, or continually changing, or could have static components and changing components. What is displayed may include characters, such as alphanumeric characters, and/or graphic components, and/or abstract components. In any event, what is displayed may include both shapes and colors.

In some embodiments, the color displayed by each individual pixel element may be provided by mechanical means, with each pixel element including an element which is flipped to display one side or the other. In preferred embodiments, the color displayed by each individual pixel element could be provided by a light for each pixel element which is either on to display the color of the light or is off to display a base color. In such an arrangement the pixel element would have a transparent or translucent front surface, and the light could be mounted immediately behind that surface or could be mounted at a distance from it and project the light onto the rear of the surface, or feed the light to the surface by an optical fiber, for example. The light could be provided by any type of known illumination device, including optoelectronic devices such as a light emitting diode. The intensity of the light displayed could be variable.

Preferably, each pixel element can display a range of colors rather than just two as with a single light—which can be on or off. This could be provided in a number of different ways. For example, instead of a single light as discussed above, a plurality of lights could be provided, each with a different color. Additionally of alternatively, each light could be capable of displaying a plurality of colors; for example, a single light emitting diode device could be capable of displaying both blue and red light. In a preferred arrangement, each pixel element is provided with sources of red, green and blue light so that by mixing the output of these sources, a visible spectrum of colors can be provided. Means are provided to control the individual sources of light and their intensities.

The color displayed by each individual pixel element can be provided by other means. Thus, the arrangement may be such that each pixel element can display multiple colors simultaneously and for example can display part of an image. This can be achieved by making each pixel element as a small electronic display screen, such as an LCD or LCD or plasma screen, that can display any chosen color. This screen could display multiple colors and could display a part of an image. The elements that make up the screen, such as LCD or LED elements, could be arranged on a flat surface, or as described earlier, could be arranged to provide a three dimensional display surface which could be convex to display in forwards and lateral directions, or substantially spherical to display in substantially all directions.

A preferred feature of embodiments of the invention is that the spatial positions of the individual pixel elements can be adjusted rapidly. One method of achieving this is to reduce mass of the pixel element and its supporting member, and having a light or an electronic display which has to be moved can cause a problem in terms of overall mass. In a preferred embodiment of the invention, the pixel element is illuminated by a stationary source of light which projects light on to the rear of the surface of the pixel element. The source of light could include separate elements for red, green and blue light and could include one or more light emitting diodes or other optoelectronic devices. A problem with such an arrangement is that as the pixel element is moved towards and away from the source of light, the intensity of the light displayed will vary. This could be compensated for by adjusting the intensity of the light output by the source, in accordance with the spatial position of the pixel element.

Where light is projected on to a pixel element, in preferred embodiments each support member is hollow so that the light can be projected on to the associated pixel element, the support member having opaque walls which will prevent the light spreading to adjacent pixel elements. Preferably each support member is in the form of a tube. The hollow support member may be enclosed completely by one or more side walls, but there may be a gap in at least one side wall, or even one side wall may be omitted. Because there is an array of pixels and thus an array of support members, a wall of an adjacent support member will prevent light which escapes through the gap of the first support member, entering the adjacent support member.

In one embodiment, adjacent the front of the display apparatus there is a grid with an array of apertures. Within each aperture there is mounted an individual elongate support member having opaque walls, carrying a pixel element, which can be slid forwards and backwards. A corresponding grid with apertures can be provided at a distance back from the first grid, so that each support member is itself supported at two spaced positions.

The means for displacing the support members can be any known type of actuator, such as mechanical, electrical, electromechanical, hydraulic or pneumatic. It should be as silent as possible during operation, and provide a rapid response to control signals which, for example, instruct the actuator to move the support member forwards, backwards or to stop.

In one preferred embodiment, each support member is provided with a follower which is driven by a lead screw, rotated by an individual electric motor.

In some embodiments, an end part of each support member, adjacent the pixel, could be transparent, translucent or semi-translucent, so that it too can display colors, as well as the pixel element. Thus, a source of light that projects onto the pixel element could also be used to illuminate a visible part of a support member when it is displaced forwards from the base configuration.

Display apparatus in accordance with the invention can be used to display information, advertisements and so forth, or can be used as a static or moving piece of art. The display apparatus could be provided in a building, either as art or to display, for example, the name and logo of a company. In serviced offices, for example, where companies may change regularly, the display apparatus could display a selected company logo in a vivid, three dimensional form.

### BRIEF DESCRIPTION OF THE DRAWINGS

The invention will be better understood by reference to the description of some preferred embodiments will now be described by way of example and with reference to the accompanying drawings, in which:

FIG. 1 is a perspective view of part of display apparatus in accordance with the invention;

FIG. 2 is an enlarged view of the font of the apparatus of FIG. 1;

FIG. 3 is an enlarged view of the drive system for the apparatus of FIG. 1;

FIG. 4 is an enlarged view of part of the drive apparatus;

FIG. 5 is a perspective view of part of the front of a panel, showing the pixels in different position;

FIG. 6 shows the cross section of a support member;

FIG. 7 shows in cross section an arrangement of alternative support members;

FIG. 8 shows diagrammatically how a pixel on a support member is illuminated; and

FIG. 9 shows an alternative arrangement in which an end portion of a support member is also illuminated.

### DETAILED DESCRIPTION OF THE EMBODIMENTS

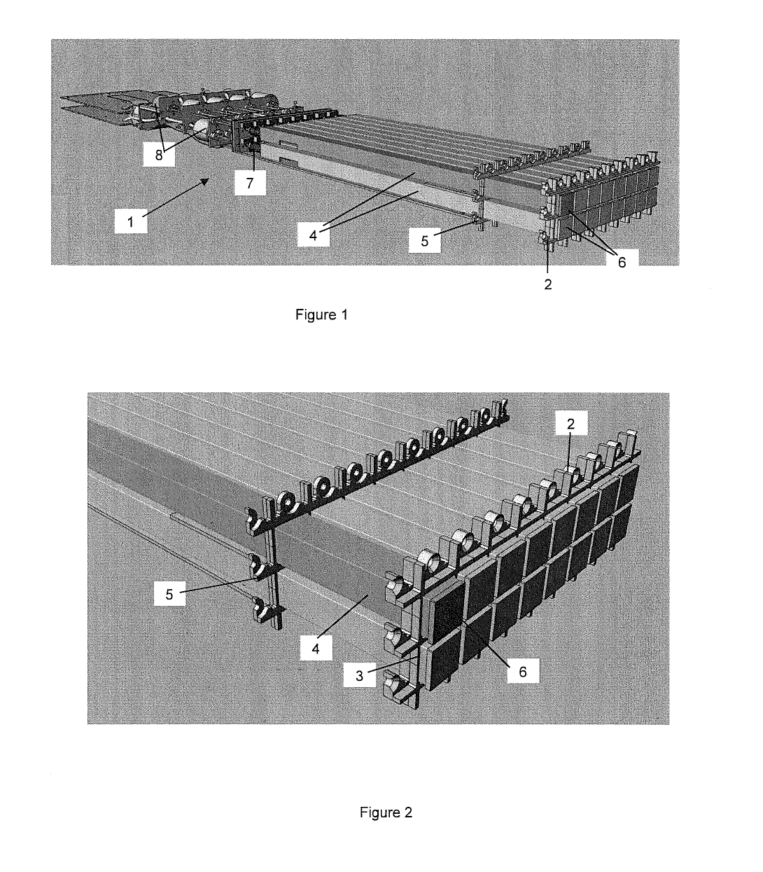

Referring now to FIGS. 1 and 2, part of a complete display apparatus 1 is shown. This is a module of sixteen display pixels with associated drive mechanisms, only eight of which are shown. There is a front supporting grid 2 of metal and/or plastic, which provides an array of square apertures 3. In each of these is slidably mounted an elongate hollow support member 4. There is also a corresponding rear supporting grid 5 through which the supports members pass. On the front of each support member is mounted a square translucent pixel element 6 which can be illuminated from the rear by light which is passed down the support member in a manner described below. As shown, the support members are all in a base configuration, with the front surfaces of the pixel elements 6 all lying in the same plane, so as to form a continuous flat surface. It will be appreciated that the surface is not strictly continuous because of the necessary gaps around each pixel element.

From this base configuration, the support members 4 and their attached pixel elements 6 can be moved forwards by a drive mechanism which for each support member includes a lead screw 7 which is rotated by an electric motor. The lead screw has a double helix, i.e. is a double start screw. One or more followers (not shown) connected to each lead screw is attached to the respective support member 4 so that if the lead screw is rotated in one sense the support member and its attached pixel element are driven forwards, and if the lead screw is rotated in the other sense the support member and its attached pixel element are driven backwards.

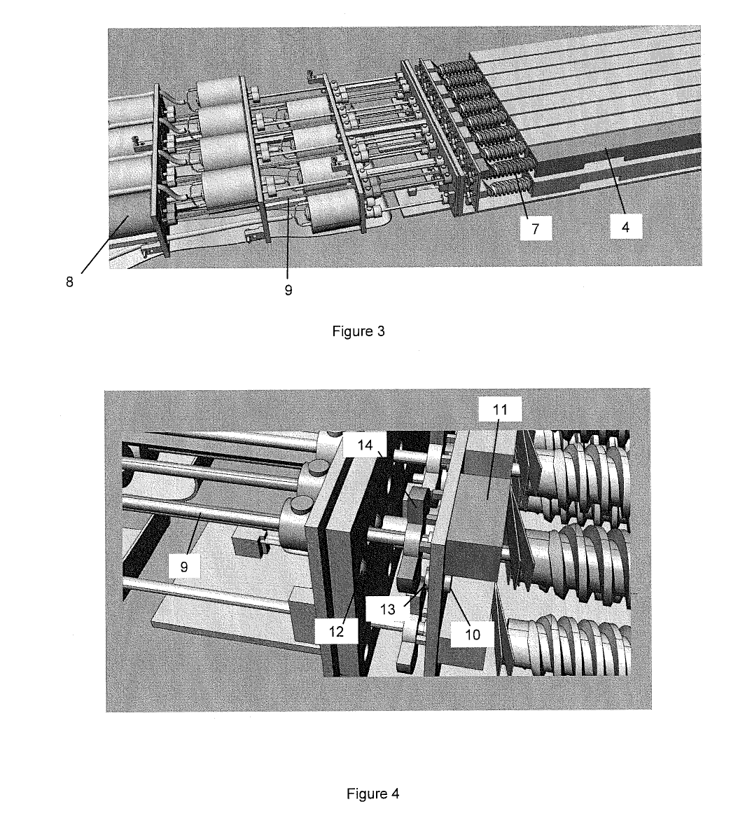

The drive mechanism is show in more detail in FIGS. 3 and 4. Each electric motor 8 is connected by a gear train to a drive shaft 9 which is connected to the lead screw 7. The use of gear trains, staggered mounting and drive shafts of different lengths enables the entire drive mechanism to be fitted into the width and depth of the display defined by the associated pixel elements.

As shown in FIG. 4, each support member is provided with a light emitting diode system 10 which can shine light down the interior of the support member to illuminate the pixel element at the end. In this embodiment the light emitting diode system includes red, green and blue light emitting diodes, so that a wide spectrum of colors can be used to illuminate the pixel element.

A backstop micro switch 11 is associated with each lead screw to prevent excessive rearward movement of the support member 4, and a corresponding front stop micro switch (not shown) is provided to limit forwards movement.

With each drive shaft 9 there are associated two infra-red light emitting diodes 12 with corresponding detectors 13 (only one diode/detector pair is shown) and a rotating interrupt member 14 mounted on the drive shaft. As the interrupt member rotates with the drive shaft 9, portions interrupt the infra-red light shone at the detector. This provides a quadrature optical encoder which is used to determine how many time the drive shaft has rotated and thus to calculate the position of the support member 4.

A data processing control module (not shown) is provided which is arranged to receive data representing material to be displayed on the display apparatus, and to control the colors of the individual pixels and their individual spatial positions through operation of the drive means, so as to display the material.

In a practical situation, several of the modules of FIGS. 1 to 4 will be arranged in an array to create a complete display, with the pixel elements 6 illuminated as required to display the required characters, and the support members of the selected pixel elements being extended to provide a desired 3D effect.

FIG. 5 shows part of a display 15 incorporating showing how support members 4, carrying pixels 6, can be extended to different positions to provide a 3D effect.

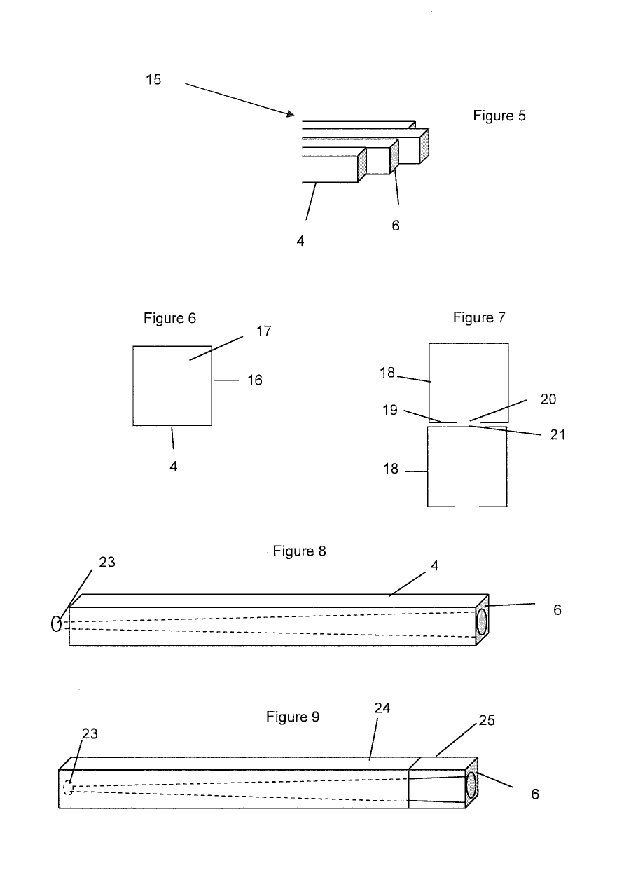

FIG. 6 shows the cross section of a support member 6, which has a rectangular cross section although other cross sections are possible. The support member has four opaque walls 16, defining a hollow interior 17. FIG. 7 shows a modified support member 18, in which one of the opaque walls 19 has an aperture 20. Light which would otherwise escape through this aperture is prevented from entering an adjacent support member 18, because it is blocked by an opaque wall 21 of that adjacent support member.

FIG. 8 shows how a pixel 6 at the end of a support member 4 is illuminated by a light source 23 which directs light inside the hollow support member where it is constrained by the opaque walls of the support member. FIG. 9 shows an alternative arrangement in which a hollow support member 24 with mostly opaque walls is provided with an end portion 25 adjacent the pixel 6 which allows light to shine through the sides of the support member, and not just through the pixel 6.

It will thus be appreciated that in the preferred embodiments there is provided display apparatus which includes an array of pixel elements, each of which can be illuminated by light shone from an individual light source for each pixel. The display apparatus has a base configuration in which the pixel forms a substantially continuous surface. Each pixel element is mounted on an individual hollow support member that transmits light from the light source to that pixel and has walls that prevent leakage of light. The support member is displaced in forwards and rearward directions by a drive mechanism provided for displacing each support member individually.

The above description and accompanying drawings are only illustrative of preferred embodiments which can provide the advantages of the present invention. It is not intended that the invention be limited to the embodiments shown and described. The invention is only limited by the spirit and scope of the following claims:

What is claimed is:

1. A display apparatus, comprising:
an array of pixel elements, each of which is operative to be illuminated by light shone from an individual light source for each pixel element;
wherein the pixel elements form a substantially continuous surface in a base configuration;
wherein each pixel element is mounted on an individual elongate hollow support member that transmits light from the light source to that pixel element and has walls that prevent leakage of light; and
wherein a drive mechanism is provided for displacing each support member individually in forwards and rearward directions.

2. The display apparatus according to claim 1, wherein a data processing module is provided which is arranged to receive data representing material to be displayed on the display apparatus, and to control the colors of the individual pixels and their individual spatial positions through operation of the drive mechanism, so as to display the material.

3. The display apparatus according to claim 1, wherein part of the support member adjacent the pixel is translucent and displays light from the light source.

4. The display apparatus according to claim 1, wherein each support member is provided with a follower which is engaged with a helix of a lead screw, and the lead screw is connected to an electric motor which is rotatable to control the position of the support member.

5. The display apparatus according to claim 1, wherein the light source for each pixel element is stationary.

6. The display apparatus according to claim 1, wherein in the base configuration the surface is flat, with all of the pixel elements lying in the same plane.

7. The display apparatus according to claim 1, wherein each individual pixel element has a flat, forward facing surface which displays the selected color for that pixel at any given time.

8. The display apparatus according to claim 1, wherein the forward facing surface of each pixel element is rectangular.

9. The display apparatus according to claim 1, wherein the individual light source for each pixel element emits a plurality of different colors.

10. The display apparatus as according to claim 9, wherein the colors include red, green and blue.

11. A display apparatus, comprising:
a frame carrying a plurality of parallel elongate, tubular support members arranged in a rectangular array, first ends of each support member terminating in a rectangular translucent pixel element, and second ends of each support member being open;
each support member being associated with an individual drive mechanism mounted on the support member for driving the support member in a longitudinal direction in a forwards sense and in a rearwards sense;
each support member further being associated with an individual light source which is arranged to direct light through the open end of the support member and along the support member so as to illuminate the pixel element;
each support member having at least one opaque wall which constrains light from the source within the support member until it reaches the pixel element; and
a data processing module that provides control signals to the individual light source and to the individual drive mechanism for each support member, thereby controlling the color and the spatial position of each pixel element independently.

12. The display apparatus according to claim 11, wherein the drive mechanism for each support member comprises a follower which is engaged with a helix of a lead screw, and the lead screw is connected to an electric motor which is rotatable to control the position of the support member.

13. The display apparatus according to claim 11, wherein the individual light source for each support member emits red, green and blue light components, and the control signals from the data processing module determine a mix of the red, green and blue light and control the color of the respective pixel elements.

14. A display apparatus, comprising:
an array of pixel elements, each of which is operative to display a selection of colors; and
means for controlling the color that is displayed by each individual pixel element;
wherein the pixel elements form a substantially continuous surface in a base configuration;
wherein each pixel element is mounted on an individual support member that is operative to be displaced in directions away from and back towards said surface; and
wherein drive mechanisms are provided for displacing each support member individually.

15. The display apparatus according to claim 14, wherein in the base configuration the surface is flat, with all of the pixel elements lying in the same plane.

16. The display apparatus according to claim 14, wherein each individual pixel element has a flat, forward facing surface which displays the selected color for that pixel at any given time.

17. The display apparatus according to claim 14, wherein each individual pixel element has a convex surface which displays in multiple directions the selected color for that pixel at any given time.

18. The display apparatus according to claim 14, wherein a plurality of light sources are provided, the support members are elongate and hollow, and the light sources transmit light inside the support members to illuminate the respective pixel elements.

19. The display apparatus according to claim 18, wherein the support member has walls which prevent the light from spreading to adjacent pixel elements.

20. The display apparatus according to claim 19, wherein part of the support member adjacent the pixel is translucent and displays light from the light source.
